(19) United States
(12) Patent Application Publication
(10) Pub. No.: US 2025/0219998 A1
(43) Pub. Date: Jul. 3, 2025

(54) SECURITY MANAGING MODULE AND SECURITY MANAGING METHOD FOR ENDPOINT DEVICE

(71) Applicant: INDUSTRIAL TECHNOLOGY RESEARCH INSTITUTE, Hsinchu (TW)

(72) Inventors: Chuan-Yu CHO, Hsinchu City (TW); Yu-Sheng LIN, Baoshan Township (TW); Chia-Hung LAI, Taichung City (TW); Hui-Kuo YANG, Zhudong Township (TW)

(73) Assignee: INDUSTRIAL TECHNOLOGY RESEARCH INSTITUTE, Hsinchu (TW)

(21) Appl. No.: 18/397,438

(22) Filed: Dec. 27, 2023

(51) Int. Cl. H04L 9/40

(52) U.S. Cl. CPC H04L 63/0263; H04L 63/0236; H04L 63/20

(57) ABSTRACT

A security managing module, includes the following elements. A capturing unit, for capturing a plurality of first program features of an application program, and capturing a plurality of first communication features of a data packet. An analyzing unit, for analyzing the first program features to generate a plurality of second program features, filtering the data packet according to a communication operation of the data packet, and analyzing the first communication features of the data packet which is filtered to generate a plurality of second communication features. A rule establishing unit, for establishing a candidate rule according to the first program features and the first communication features. A rule filtering unit, for filtering the candidate rule to generate an allow-list according to a confidence region. A security control unit, for executing a security control according to the allow-list.

### TECHNICAL FIELD

The present disclosure relates to a data processing module and a processing method thereof, and in particular relates to a security managing module and security managing method for providing cyber security of an endpoint device.

### BACKGROUND

As the number of distributed application programs in a data center has increased significantly, cyber security of communication networks has become increasingly important, so as to prevent malicious programs and intrusions. Administrators of communication networks and host devices often set application behavior allow-lists and network communication allow-lists manually. However, when the data center has a great number of server hosts, it will a heavy burden for the administrator to manually set the allow-list.

In view of the above issues, it is necessary to provide an automated security managing module that can automatically establish an allow-list and dynamically update the allow-list, and can automatically perform security control against malicious programs and illegal access.

### SUMMARY

According to one embodiment of the present disclosure, a security managing module is provided. The security managing module includes the following elements. A capturing unit, for capturing a plurality of first program features of an application program, and capturing a plurality of first communication features of a data packet. An analyzing unit, for analyzing the first program features to generate a plurality of second program features, filtering the data packet according to a communication operation of the data packet, and analyzing the first communication features of the data packet which is filtered to generate a plurality of second communication features. A rule establishing unit, for establishing a candidate rule according to the first program features and the first communication features. A rule filtering unit, for filtering the candidate rule to generate an allow-list according to a confidence region. A security control unit, for executing a security control according to the allow-list.

According to another embodiment of the present disclosure, a security managing method is provided. The security managing method includes the following steps. Capturing a plurality of first program features of an application program. Capturing a plurality of first communication features of a data packet. Analyzing the first program features to generate a plurality of second program features. Filtering the data packet according to a communication operation of the data packet. Analyzing the first communication features of the data packet which is filtered to generate a plurality of second communication features. Establishing a candidate rule according to the first program features and the first communication features. Filtering the candidate rule to generate an allow-list according to a confidence region. Executing a security control according to the allow-list.

### BRIEF DESCRIPTION OF THE DRAWINGS

FIG. 1 illustrates a block diagram of a security managing module according to an embodiment of the disclosure.

FIG. 2 illustrates a schematic diagram of security managing modules of another embodiment of the disclosure.

FIG. 3 illustrates a flow chart of a security managing method according to an embodiment of the disclosure.

FIG. 4 illustrates a schematic diagram of an embodiment for the security managing module applied to a medical environment.

FIG. 5 illustrates a schematic diagram of an embodiment for the security managing module applied to an industrial control system.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

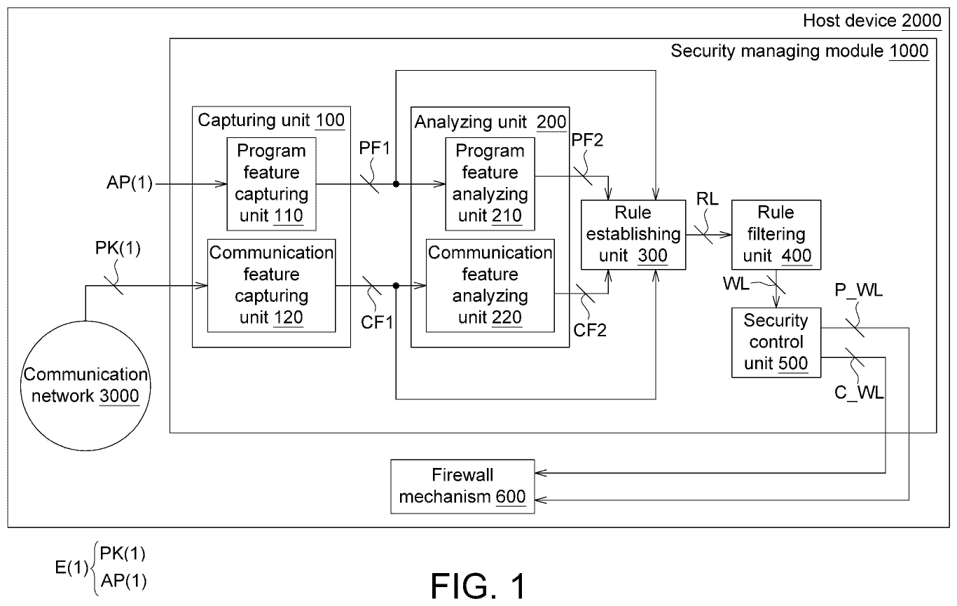

Please refer to FIG. 1, which illustrates a block diagram of a security managing module 1000 according to an embodiment of the disclosure, and illustrates the operation of the security managing module 1000. The security managing module 1000 may be a set of software program that is installed and executed in the host device 2000. The host device 2000 includes a processor and a storage device (not shown in the figure). The storage device has a non-transitory computer-readable medium, such as a non-volatile memory or a hard disk. The program code of the security managing module 1000 is stored in the non-transitory computer-readable medium of the storage device of the host device 2000. When the program code of the security managing module 1000 is read by the host device 2000, the host device 2000 executes the program code of the security managing module 1000, so as to perform various operations of the security managing module 1000.

In another example, the security managing module 1000 may be an independent hardware component (such as a microcontroller or an application specific integrated circuit (ASIC)) that may cooperate with the host device 2000.

The security managing module 1000 is applied to the host device 2000 and the communication network 3000. The host device 2000 is an endpoint device (i.e., a terminal node), and the communication network 3000 is installed in the host device 2000. The security managing module 1000 analyzes an event E(1) in the host device 2000 and the communication network 3000. The event E(1) includes an application program AP(1) and a data packet PK(1). The application program AP(1) is related to the host device 2000, and the application program AP(1) is executed in an operating platform of the host device 2000. Furthermore, the data packet PK(1) is related to the communication network 3000, and the data packet PK(1) is transmitted through the communication network 3000 and sent to the host device 2000.

The security managing module 1000 includes a capturing unit 100, an analyzing unit 200, a rule establishing unit 300, a rule filtering unit 400 and a security control unit 500. The above-mentioned units are respectively sub-routine modules in the security managing module 1000. The capturing unit 100 further includes a program feature capturing unit 110 and a communication feature capturing unit 120. Furthermore, the analyzing unit 200 further includes a program feature analyzing unit 210 and a communication feature analyzing unit 220.

The application program AP(1) and the data packet PK(1) are under-test targets which are monitored by the security managing module 1000. The capturing unit 100 captures respective features of the application program AP(1) and the data packet PK(1) from the communication network 3000 and the host device 2000. More specifically, the program feature capturing unit 110 of the capturing unit 100 captures the first program feature PF1 of the application program AP(1) from the host device 2000. Furthermore, the communication feature capturing unit 120 of the capturing unit 100 captures the first communication feature CF1 of the data packet PK(1) from the communication network 3000.

The analyzing unit 200 is coupled to the capturing unit 100 to receive the first program feature PF1 of the application program AP(1) and the first communication feature CF1 of the data packet PK(1). The program feature analyzing unit 210 of the analyzing unit 200 is coupled to the program feature capturing unit 110 to receive the first program feature PF1, and the program feature analyzing unit 210 analyzes the first program feature PF1 to generate the second program feature PF2. Similarly, the communication feature analyzing unit 220 of the analyzing unit 200 is coupled to the communication feature capturing unit 120 to receive the first communication feature CF1, and the communication feature analyzing unit 220 analyzes the first communication feature CF1 to generate a second communication feature CF2.

The rule establishing unit 300 is coupled to the capturing unit 100 to receive the first program feature PF1 and the first communication feature CF1, and is coupled to the analyzing unit 200 to receive the second program feature PF2 and the second communication feature CF2. The rule establishing unit 300 summarizes the program features and communication features in a normal behavior mode according to the first program feature PF1 of the application program AP(1) and the first communication feature CF1 of the data packet PK(1), and thereby establishes a candidate rule RL. For example, among the communication features in the normal behavior mode, the change of unit traffic of the communication transmission of the data packet PK(1) is “1 GB”. Moreover, selectively, the rule establishing unit 300 may further establish the candidate rule RL according to the second program feature PF2 of the application program AP(1) and the second communication feature CF2 of the data packet PK(1). In other words, when establishing the candidate rule RL the rule establishing unit 300 must analyze the first program feature PF1 and the first communication feature CF1, but the second program feature PF2 and the second communication feature CF2 are not necessary (only for assistance).

The rule filtering unit 400 is coupled to the rule establishing unit 300 to receive candidate rule RL. Furthermore, the rule filtering unit 400 filters the candidate rule RL according to a confidence region to generate an allow-list WL. The allow-list WL includes a program allow-list P_WL and a communication allow-list C_WL.

The security control unit 500 is coupled to the rule filtering unit 400 to receive the allow-list WL, and perform security control according to the program allow-list P_WL and the communication allow-list C_WL of the allow-list WL. For example, the security control unit 500 applies the program allow-list P_WL and the communication allow-list C_WL to the program firewall mechanism and communication firewall mechanism of the host device 2000 respectively. Furthermore, the security control unit 500 monitors subsequent under-test application programs and under-test data packets according to the program allow-list P_WL and the communication allow-list C_WL, so as to determine whether they comply with the program allow-list P_WL and the communication allow-list C_WL.

The following paragraphs describe detailed operations of the capturing unit 100, the analyzing unit 200, the rule establishing unit 300, the rule filtering unit 400 and the security control unit 500. The program feature capturing unit 110 and the communication feature capturing unit 120 of the capturing unit 100 automatically capture the first program feature PF1 of the application program AP(1) and the first communication feature CF1 of the data packet PK(1). In one example, the program feature capturing unit 110 captures the first program feature PF1 according to the program operation of the application program AP(1) in the host device 2000 (i.e., the endpoint device). For example, the operating platform of the host device 2000 is “linux”, and the program feature capturing unit 110 executes the command “ps-ef” of linux to access a log file of the host device 2000, thereby capturing the first program feature PF1 of the application program AP(1). The captured first program feature PF1 includes, for example, the program name (or, application name) and program check code (e.g., checksum) of the application program AP(1), and selectively includes: a path name, a process ID (PID), a parent process ID (PPID), a CPU usage, a program start-time, a program end-time, a system call sequence, etc. Table 1 lists some of the first program features PF1.

TABLE 1

| | |
|---|---|
| USER | user login name |
| PID | process ID |
| PPID | parent process ID |
| C | CPU usage |
| STIME | program start-time |
| TTY | control station of process |
| TIME | total execution time |
| CMD | command |

The communication feature capturing unit 120 may operate synchronously or asynchronously with the program feature capturing unit 110. The communication feature capturing unit 120 captures the first communication feature CF1 of the data packet PK(1) according to the communication operation of the data packet PK(1) in the communication network 3000. For example, the communication feature capturing unit 120 executes the open source program “tcp dump” on the data packet PK(1) to capture the first communication feature CF1, which includes, e.g., an Internet Protocol (IP) source address (src IP) and an IP destination address (dst IP), and selectively includes: communication protocol (such as Transmission Control Protocol (TCP)), media access control address (MAC address), source port (src port), destination port (dst port) and packet size, etc.

The program feature analyzing unit 210 analyzes the first program feature PF1 according to the program operation of the application program AP(1) on the host device 2000, so as to generate the second program feature PF2. The second program feature PF2 includes, e.g., an execution frequency, a total execution time and an interval of starting of the application program AP(1). For example, the program feature analyzing unit 210 calculates the execution frequency and the interval of starting (the second program feature PF2) of the application program AP(1) according to each of program start time (the first program feature PF1). Furthermore, the program feature analyzing unit 210 calculates the total execution time (second program feature PF2) of the application program AP(1) according to the program start time and program end time (the first program feature PF1) of the application program AP(1).

The communication feature analyzing unit 220 can operate synchronously or asynchronously with the program feature analyzing unit 210. The communication feature analyzing unit 220 analyzes the first communication feature CF1 according to the communication operation of the data packet PK(1) in the communication network 3000 to generate the second communication feature CF2. The second communication feature CF2 includes, e.g., a connecting number for communication or a change of unit traffic of the communication transmission of the data packet PK(1). For example, the communication feature analyzing unit 220 statistically analyzes the IP source address and the IP destination address (first communication feature CF1) of the data packet PK(1) to calculate the connecting number for communication (the second communication feature CF2). In one example, the communication feature analyzing unit 220 can filter the data packet PK(1) according to the communication operation, when the data packet PK(1) does not belong to the object to be analyzed, the data packet PK(1) is filtered out. For example, the security managing module 1000 performs security control for the host device 2000 as an endpoint device, therefore, the data packet PK(1) irrelevant to the endpoint device role does not belong to the object to be analyzed and is filtered out. When the communication operation of the data packet PK(1) in the communication network 3000 is “broadcast operation” or “forwarding operation” regardless of the endpoint device role, the communication feature analyzing unit 220 filters out the data packet PK(1) without performing analysis.

The rule establishing unit 300 automatically establishes candidate rule RL according to the first program feature PF1 and the first communication feature CF1, without the need of manual establishing by the user. Moreover, when establishing the candidate rule RL, the rule establishing unit 300 may further selectively consider the second program feature PF2 and the second communication feature CF2. In one example, the rule establishment unit 300 may perform statistical analysis on the historical data set HS to establish the candidate rule RL. In another example, the rule establishment unit 300 may use a computational model MDL to perform deep learning to establish the candidate rule RL. The computational model MDL is, for example, a convolutional neural network (CNN).

In the example of establishing the candidate rule RL using the computational model MDL, the rule establishing unit 300 firstly generates a training data set TR to train the computational model MDL. The rule establishing unit 300 can summarize the program features and communication features in the normal behavior mode based on the first program feature PF1, the second program feature PF2, the first communication feature CF1, and the second communication feature CF2, and perform pre-data-process on them to generate the training data set TR. The pre-data-process of the training data set TR includes, e.g., encoding process and classifying and labeling process, so that the data type of the training data set TR after pre-data-process can comply with the computing model MDL. For example, performing a encoding process of “One-Hot encoding” on the TCP protocol and UDP protocol in the first communication feature CF1, so that the TCP protocol is encoded as “00001” and the UDP protocol is encoded as “00010”. Furthermore, the rule “iptables-A INPUT-s 11.22.33/24-j ACCEPT” is performed with the classifying and labeling process and defined as a label of “6”. Alternatively, the change of unit traffic of “1 GB” in the normal behavior mode is defined as a label of “1”, and the change of unit traffic of “5 GB” (which is abnormal) is defined as a label of “0”.

Furthermore, the rule establishing unit 300 can test the computational model MDL according to the test data set TST, so as to evaluate the accuracy of the candidate rule RL generated by the computational model MDL. In addition, the rule establishing unit 300 may dynamically update the program allow-list P_WL and the communication allow-list C_WL according to new program features (i.e., first program features and/or second program features) and new communication features (i.e., first communication features and/or second communication features) of subsequent events.

The rule filtering unit 400 sets the confidence region according to a predetermined quantity and a predetermined ratio. For example, the confidence region is set as less than or equal to 100 items, or set as a ratio of “80/20”, or set as three times of a standard deviation when using a normal distribution (i.e., a region of 99.7%). The rule filtering unit 400 filters the allow-list WL from the candidate rule RL according to the ratio or quantity of the confidence region, which may prevent the allow-list WL from excess items, so as to save computing time of the security control unit 500.

The security control unit 500 performs security control according to the program allow-list P_WL and the communication allow-list C_WL in the allow-list WL. The host device 2000 has a firewall mechanism 600. The firewall mechanism 600 includes a program firewall mechanism and a communication firewall mechanism. The security control unit 500 applies the program allow-list P_WL and the communication allow-list C_WL to the program firewall mechanism and the communication firewall mechanism respectively. The security control unit 500 has a monitoring mode and a blocking mode. The program firewall mechanism and the communication firewall mechanism can selectively activate the program allow-list P_WL and the communication allow-list C_WL according to different modes. In the monitoring mode, the program firewall mechanism and the communication firewall mechanism do not actually activate the program allow-list P_WL and the communication allow-list C_WL. The security control unit 500 only uses the program allow-list P_WL and the communication allow-list C_WL to monitor the under-test application program and the under-test data packet. When an abnormality is detected, the security control unit 500 only issues a warning. In the blocking mode, the program firewall mechanism and the communication firewall mechanism can actually activate the program allow-list P_WL and the communication allow-list C_WL. When an abnormality is detected, the security control unit 500 controls the program firewall mechanism and the communication firewall mechanism to block abnormal application programs or abnormal data packets.

In the example of Table 2, the program features of normal behavior mode in the program allow-list P_WL include: total execution time is “20 minutes”. If total execution time of the under-test application program is “20 minutes” which complies with the program allow-list P_WL, this application program is determined as normal can be allowed to operate in the host device 2000. On the other hand, if total execution time of another under-test application program is “120 minutes” which does not comply with the program allow-list P_WL, this application program is determined as having abnormal behavior (may be a malicious program), and the security control unit 500 blocks or stops the application program (i.e., when in the blocking mode) or only issues a warning (i.e., when in the monitoring mode).

TABLE 2

| | comm, | | | | | |
|---|---|---|---|---|---|---|
| security | on | | | starting | | program |
| control | protocol | src port | dst port | time | end time | name |
| allow | under-test application program | | | | | |
| | Tcp | 600 | 600 | 10:15 | 10:35 | surgery |
| stop | under-test application program | | | | | |
| operating | Tcp | 600 | 600 | 10:15 | 12:15 | surgery |

Similarly, the security control unit 500 monitors the under-test data packet. As shown in Table 3, several communication features of the under-test data packet include, e.g., communication protocol, source address, source port, destination address and destination port. The security control unit 500 determines whether the under-test data packet is abnormal according to whether it complies with the communication allow-list C_WL.

TABLE 3

| | comm. | | src | | dst |
|---|---|---|---|---|---|
| attribute | protocol | src address | port | dst address | port |
| legal | UDP | 140.96.27.240 | any | 239.255.255.250 | any |
| legal | UDP | 140.96.27.44 | any | 239.255.255.250 | any |
| legal | UDP | 140.96.27.143 | any | 239.255.255.250 | any |
| legal | UDP | 140.96.27.18 | any | 140.96.27.255 | any |
| legal | UDP | 140.96.27.208 | any | 224.0.0.253 | any |
| legal | UDP | 140.96.27.254 | any | 140.96.27.255 | any |

In the example of Table 4, the destination port of the normal behavior mode in the communication allow-list C_WL is “600”. If the destination port of the under-test data packet is “600” which complies with the communication allow-list C_WL, it is determined that the data packet is a legal access. On the other hand, if the destination port of another under-test data packet is “650” which does not comply with the communication allow-list C_WL, it is determined as having abnormal behavior and being an illegal access. The security control unit 500 can block illegally accessed data packets (i.e., when in the blocking mode) or only issue a warning (i.e., when in the monitoring mode).

TABLE 4

| security | comm. | src | src | | | program |
|---|---|---|---|---|---|---|
| control | protocol | address | port | dst address | dst port | name |
| allow | under-test data packet | | | | | |
| | Tcp | 11.22.33.10 | 600 | 11.22.33.12 | 600 | surgery |
| block | under-test data packet | | | | | |
| | Tcp | 11.22.33.10 | 600 | 11.22.33.12 | 650 | surgery |

As another example in Table 5, the connecting number is “50” in the normal behavior mode in the communication allow-list C_WL. If the connecting number is “50” for the under-test data packet which complies with the communication allow-list C_WL, it is determined that this data packet is a legal access. On the other hand, if the connecting number is “500” for another data packet which does not comply with the communication allow-list C_WL, it is determined that the data packet is an illegal access.

TABLE 5

| security | comm. | src | src | | dst | connecting |
|---|---|---|---|---|---|---|
| control | protocol | address | port | dst address | port | number |
| allow | under-test data packet | | | | | |
| | Tcp | 11.22.33.10 | 600 | 11.22.33.12 | 600 | 50 |
| block | under-test data packet | | | | | |
| | Tcp | 11.22.33.10 | 600 | 11.22.33.12 | 650 | 500 |

The communication firewall mechanism can respectively process (allow or block) data packets of input type, output type and forward type of communication connections. The input type is a communication connection between an external device (such as remote SSH) and the local host device 2000 via the communication network 3000. The output type is the communication connection between the local host device 2000 and the external device through the communication network 3000. The forward type is a communication connection from an external device and forwarded to other devices, with its destination being not the host device 2000.

In summary, the security control unit 500 automatically applies the program allow-list P_WL and the communication allow-list C_WL to the program firewall mechanism and communication firewall mechanism of the host device 2000. The user does not need to manually change the security management rules, security control policy and parameter settings of the program firewall mechanism and communication firewall mechanism. Moreover, the program firewall mechanism and the communication firewall mechanism can selectively activate the program allow-list P_WL and the communication allow-list C_WL. The security control unit 500 can automatically block malicious programs or illegal access, or issue warnings for them. The user can also choose block malicious programs or illegal access under manual intervention.

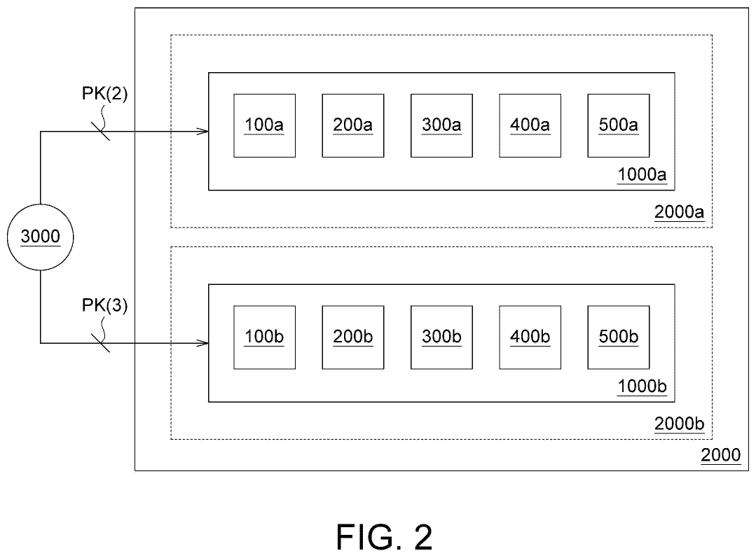

Please refer to FIG. 2, which is a schematic diagram of security managing modules 1000a and 1000b of another embodiment of the disclosure. For the host device 2000 to be protected, the security managing modules 1000a and 1000b can be installed in the container or virtual machine associated with the host device 2000, so as to collect information of program features or communication features, also establish and update the allow-list WL. For example, the security managing module 1000a can be installed in the virtual machine 2000a associated with the host device 2000, and the security managing module 1000b can be installed in the virtual machine 2000b associated with the host device 2000.

Similar to the security managing module 1000 of the embodiment of FIG. 1, the security managing module 1000a of this embodiment includes a capturing unit 100a, an analyzing unit 200a, a rule establishing unit 300a, a rule filtering unit 400a and a security control unit. 500a. The above-mentioned units are respectively sub-routine modules in the security managing module 1000a. Similarly, the security managing module 1000b also includes a capturing unit 100b, an analyzing unit 200b, a rule establishing unit 300b, a rule filtering unit 400b and a security control unit 500b.

FIG. 2 only shows an example of processing data packets (does not include processing application program): the security managing modules 1000a and 1000b monitor the under-test data packets PK(2) and PK(3) from the communication network 3000, thereby protecting the host device 2000 from illegal access and malicious program attacking. In operation, the capturing unit 100a acquires the first communication feature CF1 of the data packet PK(2) from the communication network 3000. The analyzing unit 200a analyzes the first communication feature CF1 to generate a second communication feature CF2 of the data packet PK(2). The rule establishing unit 300a establishes candidate rule RL according to the first communication feature CF1 (or selectively considering the second communication feature CF2). The rule filtering unit 400a filters the candidate rule RL according to the confidence region to generate a communication allow-list C_WL. The security control unit 500a performs security control according to the communication allow-list C_WL to protect the host device 2000. Similarly, the capturing unit 100b, analyzing unit 200b, rule establishing unit 300b, rule filtering unit 400b and security control unit 500b of the security managing module 1000b have the same operation manner, which will not be described again.

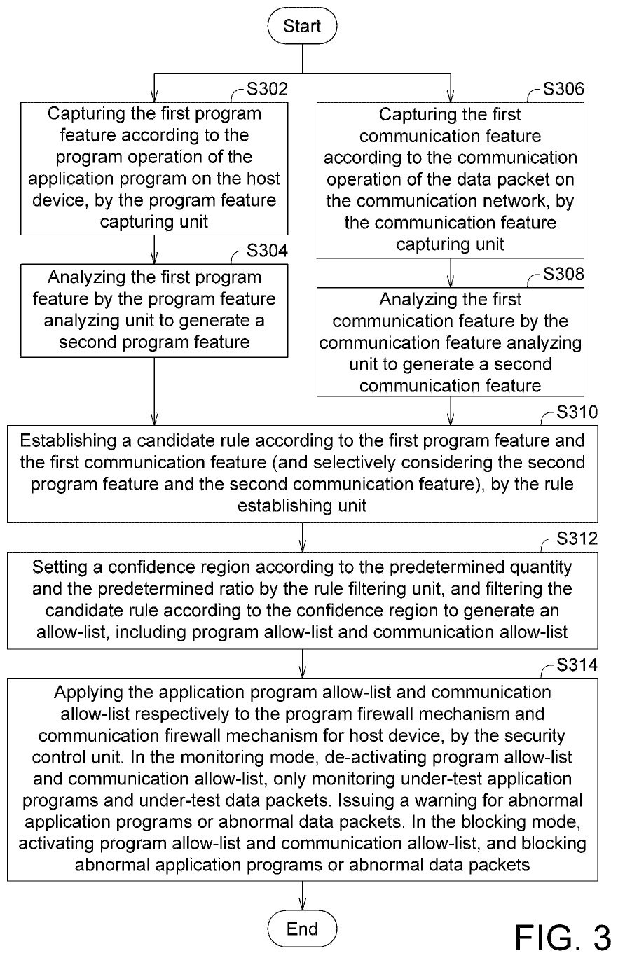

Please refer to FIG. 3, which illustrates a flow chart of a security managing method according to an embodiment of the disclosure. The security managing method can be carried out by the security managing module 1000 in FIG. 1. For example, as mentioned above, when the program code of the security managing module 1000 is read by the host device 2000, the host device 2000 executes the program code of the security managing module 1000 to carry out the security managing method.

First, step S302 is executed: the program feature capturing unit 110 captures the first program feature PF1 according to the program operation of the application program AP(1) on the host device 2000. For example, the program feature capturing unit 110 executes the “linux” command “ps-ef” to access the log file of the host device 2000, thereby capturing the first program feature PF1 of the application program AP(1). Next, step S304 is executed: the first program feature PF1 is analyzed by the program feature analyzing unit 210 to generate a second program feature PF2.

Furthermore, step S306 and step S308 are executed (which may be executed synchronously or asynchronously with step S302 and step S304). In step S306, the communication feature capturing unit 120 captures the first communication feature CF1 according to the communication operation of the data packet PK(1) in the communication network 3000. For example, the communication feature capturing unit 120 executes the open source program “tcp dump” to capture the first communication feature CF1. Next, step S308 is executed: the communication feature analyzing unit 220 analyzes the first communication feature CF1 to generate a second communication feature CF2.

After step S304 and step S308, step S310 is then executed: the rule establishing unit 300 establishes a candidate rule RL according to the first program feature PF1 and the first communication feature CF1. Selectively, the rule establishing unit 300 may further consider the second program feature PF2 and the second communication feature CF2 to establish the candidate rule RL (i.e., when establishing the candidate rule RL, the rule establishing unit 300 must refer to the first program feature PF1 and the first communication feature CF1 to establish the candidate rule RL, on the other hand, the second program feature PF2 and the second communication feature CF2 are only used as selective assistance). In one example, the rule establishment unit 300 may utilize deep learning of the computational model MDL to establish the candidate rule RL. In another example, the rule establishment unit 300 may establish the candidate rule RL using the historical data set HS.

Next, step S312 is executed: the rule filtering unit 400 sets a confidence region according to the predetermined quantity and the predetermined ratio, and filters the candidate rule RL according to the confidence region to generate an allow-list WL. The allow-list WL includes program allow-list P_WL and communication allow-list C_WL.

Next, step S314 is executed: the security control unit 500 performs security control according to the program allow-list P_WL and the communication allow-list C_WL. The security control unit 500 applies the program allow-list P_WL and the communication allow-list C_WL to the program firewall mechanism and communication firewall mechanism of the host device 2000 respectively. The security control unit 500 may set the program firewall mechanism and the communication firewall mechanism of the host device 2000 as different modes. In the monitoring mode, the program firewall mechanism and the communication firewall mechanism of the host device 2000 do not actually activate the program allow-list P_WL and the communication allow-list C_WL. The security control unit 500 only monitors the under-test application program and the under-test data packet according to the program allow-list P_WL and the communication allow-list C_WL. When an abnormality is detected, the security control unit 500 issues a warning. In the blocking mode, the program firewall mechanism and the communication firewall mechanism of the host device 2000 actually activate the program allow-list P_WL and the communication allow-list C_WL. When an abnormality is detected, the security control unit 500 controls the program firewall mechanism and the communication firewall mechanism to block abnormal application program or abnormal data packets.

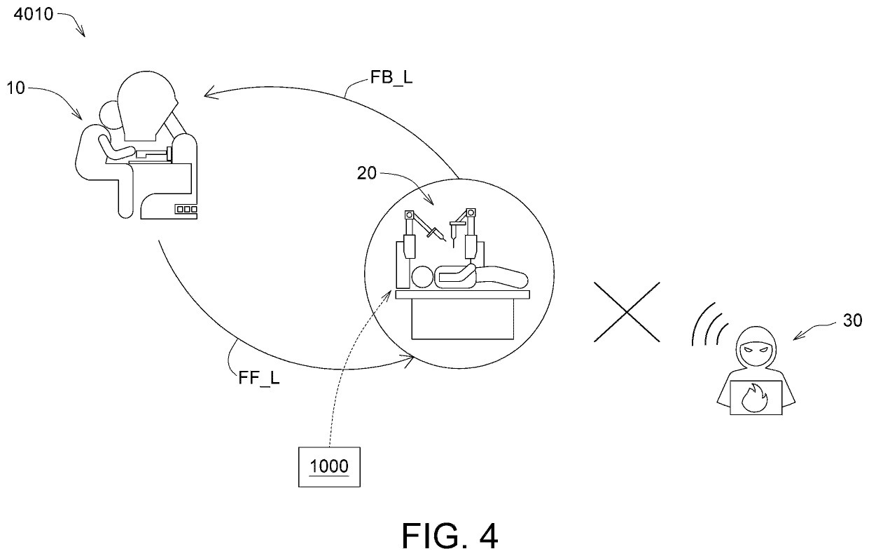

The security managing module 1000 and security managing method in the embodiments of FIGS. 1-3 may be used in different environments and purposes, including industrial control (e.g., unmanned vehicles (UAV)), finance (e.g., automated teller machines (ATM)), military (e.g. drones) and medical (e.g. Da-Vinci arm surgery), etc. Please refer to FIG. 4, which is a schematic diagram of an embodiment for the security managing module 1000 applied to a medical environment 4010. In the medical environment 4010, the surgeon operates the Da-Vinci arm 20 through the remote control device 10 to perform a surgical operation. The remote control device 10 transmits control commands to the Da-Vinci arm 20 via the feed-forward link FF_L. The Da-Vinci arm 20 transmits status signals to the remote control device 10 via the feed-back link FB_L. The security managing module 1000 may be installed in the driver host of the Da-Vinci arm 20 to prevent malicious programs from intruding into the remote control device 10 and the Da-Vinci arm 20. The operation of the security managing module 1000 is shown in Table 6.

TABLE 6

| security | user | | | |
|---|---|---|---|---|
| control | name | program name | path name | checksum |
| allow | under-test application program | | | |
| | Wein | Surgery | /home/Wein/patient | 0xcd |
| deny | under-test application program | | | |
| | Wein | Surgery | /home/Wein/patient | 0xcf |

In Table 6, the program features of the normal behavior mode in the program allow-list P_WL include: the checksum result is “0xcd”. If the checksum result of the under-test application program is “0xcd” which complies with the program allow-list P_WL, this application program is determined as normal. On the other hand, if the checksum result of another under-test application program is “0xcf” which does not comply with the program allow-list P_WL, it is determined that the application program has abnormal behavior and may be a malicious program from a malicious third party 30. Therefore, the security control unit 500 may deny the application program to be executed on the driving host of the Da-Vinci arm 20.

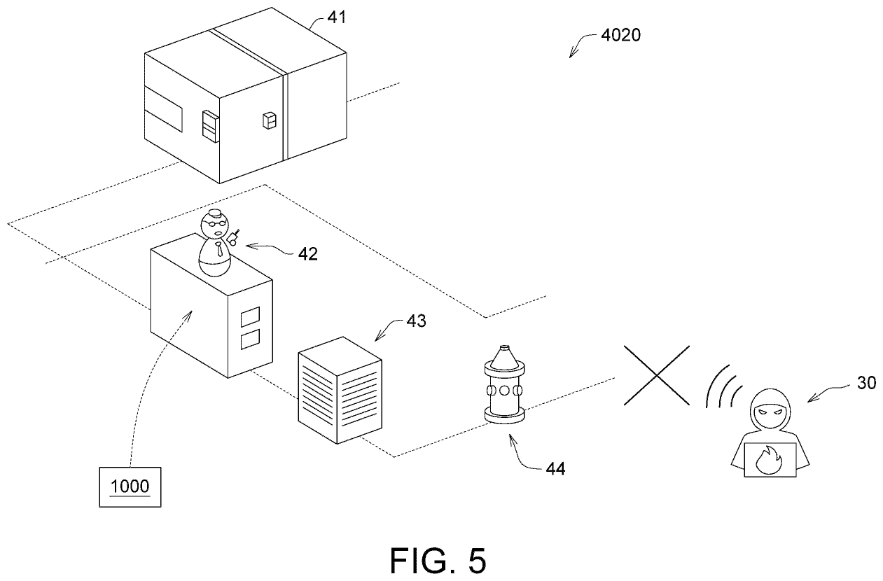

Please refer to FIG. 5, which is a schematic diagram of an embodiment for the security managing module 1000 applied to an industrial control system 4020. The industrial control system 4020 is provided with production machines 41 and 43 and a control host 42. Moreover, the industrial control system 4020 further includes peripheral facilities 44. The security managing module 1000 may be installed in the control host 42 to prevent malicious programs from intruding into the production machines 41 and 43, the control host 42 and peripheral facilities 44. The operation of the security managing module 1000 is shown in Table 7.

TABLE 7

| security | user | | | |
|---|---|---|---|---|
| control | name | program name | path name | checksum |
| allow | under-test application program | | | |
| | Wein | Platform | /home/Wein/industry | 0xcd |
| deny | under-test application program | | | |
| | Wein | machine | /home/Wein/industry | 0xca |

In Table 7, the program features of the normal behavior mode in the program allow-list P_WL include: the checksum result “0xcd” and the program name “platform”. If the checksum result “0xca” of the under-test application program does not match that of “0xcd” of the program allow-list P_WL, and its program name “machine” does not match that of “platform” of the program allow-list P_WL, it is determined that this application program may be a malicious program from a malicious third party 30. Therefore, the security control unit 500 may deny the application program to be executed in the production machines 41 and 43, the control host 42 or the peripheral facilities 44.

In summary, the security managing module 1000 of the disclosure provides an automated cyber security self-hardening mechanism for the host device 2000 (the host device 2000 serves a role of an endpoint device). In the security control of general program allow-lists and network communication allow-lists, system administrators mostly set the rules manually, lacking a dynamic update mechanism, hence errors are easy to occur, or protection is incomplete. In contrast, the security managing module 1000 of the disclosure may collect program log files and network communication logs of the host device 2000 which under protected, and thereby automatically learn, generate, and dynamically update the allow-list WL. Hence, user's time cost of manual intervention may be saved.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A security managing module, comprising:
a capturing unit, for capturing a plurality of first program features of an application program, and capturing a plurality of first communication features of a data packet;
an analyzing unit, for analyzing the first program features to generate a plurality of second program features, filtering the data packet according to a communication operation of the data packet, and analyzing the first communication features of the data packet which is filtered to generate a plurality of second communication features;
a rule establishing unit, for establishing a candidate rule according to the first program features and the first communication features;
a rule filtering unit, for filtering the candidate rule to generate an allow-list according to a confidence region; and
a security control unit, for executing a security control according to the allow-list.

2. The security managing module according to claim 1, wherein when the communication operation of the data packet is a broadcast operation or a forward operation, the analyzing unit filters out the data packet.

3. The security managing module according to claim 1, wherein the allow-list comprises a program allow-list and a communication allow-list, and the rule establishing unit further selectively establishes the candidate rule according to the second program features and the second communication features, and updates the program allow-list according to the first program features and/or the second program features, and updates the communication allow-list according to the first communication features and/or the second communication features.

4. The security managing module according to claim 3, wherein the security control unit applies the program allow-list and the communication allow-list to a program firewall mechanism and a communication firewall mechanism of a host device respectively.

5. The security managing module according to claim 4, wherein the security control unit determines whether an under-test application program complies with the program allow-list, and determines whether an under-test data packet complies with the communication allow-list.

6. The security managing module according to claim 5, wherein in a blocking mode, when the under-test application program does not comply with the program allow-list, the program firewall mechanism stops the under-test application program, when the under-test data packet does not comply with the communication allow-list, the communication firewall mechanism blocks the under-test data packet.

7. The security managing module according to claim 5, wherein in a monitoring mode, when the under-test application program does not comply with the program allow-list, or the under-test data packet does not comply with the communication allow-list, the safety control unit issues a warning.

8. The security managing module according to claim 1, wherein the first program features at least comprise a program name and a program check code, and the second program features comprise an execution frequency or an interval of starting.

9. The security managing module according to claim 1, wherein the first communication features at least comprise an Internet Protocol (IP) source address and an IP destination address, and the second communication features comprise a connecting number for communication or a change of unit traffic.

10. The security managing module according to claim 1, wherein the rule establishing unit performs a pre-data-process on the first program features, the second program features, the first communication features and the second communication features to generate a training data set, and using the training data set to train a computational model to establish the candidate rule, the pre-data-process at least comprises an encoding process or a classifying and labeling process.

11. A security managing method, comprising the following steps:
capturing a plurality of first program features of an application program;
capturing a plurality of first communication features of a data packet;
analyzing the first program features to generate a plurality of second program features;
filtering the data packet according to a communication operation of the data packet;
analyzing the first communication features of the data packet which is filtered to generate a plurality of second communication features;
establishing a candidate rule according to the first program features and the first communication features;
filtering the candidate rule to generate an allow-list according to a confidence region; and
executing a security control according to the allow-list.

12. The security managing method according to claim 11, wherein the step of filtering the data packet comprises:
when the communication operation of the data packet is a broadcast operation or a forward operation, filtering out the data packet.

13. The security managing method according to claim 11, wherein the allow-list comprises a program allow-list and a communication allow-list, and the security managing method further comprises:
selectively establishing the candidate rule according to the second program features and the second communication features;
updating the program allow-list according to the first program features and/or the second program features; and
updating the communication allow-list according to the first communication features and/or the second communication features.

14. The security managing method according to claim 13, wherein the step of executing the security control according to the allow-list further comprises:
applying the program allow-list and the communication allow-list to a program firewall mechanism and a communication firewall mechanism of a host device respectively.

15. The security managing method according to claim 14, wherein the step of executing the security control according to the allow-list further comprises:
determining whether an under-test application program complies with the program allow-list; and
determining whether an under-test data packet complies with the communication allow-list.

16. The security managing method according to claim 15, wherein in a blocking mode, when the under-test application program does not comply with the program allow-list, or when the under-test data packet does not comply with the communication allow-list, the step of performing the security control comprises:
stopping the under-test application program by the program firewall mechanism; or
blocking the under-test data packet by the communication firewall mechanism.

17. The security managing method according to claim 15, wherein in a monitoring mode, when the under-test application program does not comply with the program allow-list, or when the under-test data packet does not comply with the communication allow-list, the step of performing the security control comprises issuing a warning.

18. The security managing method according to claim 11, wherein the first program features at least comprise a program name and a program check code, and the second program features comprise an execution frequency or an interval of starting.

19. The security managing method according to claim 11, wherein the first communication features at least comprise an Internet Protocol (IP) source address and an IP destination address, and the second communication features comprise a connecting number for communication or a change of unit traffic.

20. The security managing method according to claim 11, wherein the step of establishing the candidate rule comprises:
performing a pre-data-process on the first program features, the second program features, the first communication features and the second communication features to generate a training data set; and
using the training data set to train a computational model to establish the candidate rule;
wherein, the pre-data-process at least comprises an encoding process or a classifying and labeling process.
